(19) United States
(12) Patent Application Publication
(10) Pub. No.: US 2016/0255439 A1
(43) Pub. Date: Sep. 1, 2016

(54) Tunable Ribbon Microphone

(71) Applicant: Mohsen GHAFFARI, Los Angeles, CA (US)

(72) Inventors: Mohsen GHAFFARI, LOS ANGELES, CA (US); Maryam GHAFFARI, TEHRAN (IR)

(21) Appl. No.: 14/916,468

(22) PCT Filed: Nov. 12, 2014
(86) PCT No.: PCT/US14/65253

§ 371 Date: Mar. 3, 2016

Related U.S. Application Data
(60) Provisional application No. 61/907,265, filed on Nov. 21, 2013.

(51) Int. Cl. H04R 9/04; H04R 9/02; H04R 9/08

(52) U.S. Cl. CPC H04R 9/048; H04R 9/08; H04R 9/025; H04R 9/045

(57) ABSTRACT

A tunable ribbon microphone having magnets positioned within a small gap in between pieces of opposite poles. A conductive ribbon placed in an air gap between the magnets by an adjustable ribbon holder structure. The adjustable ribbon holder structure includes two ribbon holders and a ribbon tension control. The ribbon holder can be fixed from one side by sliding on one side or sliding on both sides. The ribbon tension control adjusts the tension of the elastic ribbon. By turning the ribbon tension control, turning motion translate to linear motion and change the distance between the ribbon holders and alter the tension of the ribbon. Changing the ribbon tension also possible by different ribbon tension control mechanism by rolled or folded the ribbon in one side or both side of the microphone. The tunable ribbon microphone may have more than one ribbon, adjustable ribbon holder structure and ribbon tension control.

### RELATED APPLICATIONS

The present application is a continuation-in-part application of U.S. provisional patent application Ser. No. 61/907,265, filed Nov. 21, 2013, for TUNABLE RIBBON MICROPHONE, by Mohsen Ghaffari, included by reference herein and for which benefit of the priority date is hereby claimed.

### FIELD OF THE INVENTION

The present invention relates to ribbon microphones and, more particularly, to tunable ribbon microphone.

### BACKGROUND OF THE INVENTION

Ribbon microphones have a dominant footprint in recording history, and it rise and fall in different period of times. In 1950's popularity of the ribbon microphones were at the peak.

The ribbon microphones made by use of two separate magnets placed in parallel by the opposite pole with an air gap in between to generate a high magnetic field. A thin aluminum foil ribbon placed in the middle of the magnetic field. The movement of the ribbon generates an electrical signal. The signal increase by ratio of 1:20 or 1:25 with the use of a transformer.

Early ribbon microphones have very low current signal output due to weak magnetic field produced by available magnets at that time. Many methods are employed to reach stronger magnetic field such as increasing the size of the magnets, tapered the magnets or use ferromagnetic material to concentrating the magnetic field in the ribbon area. Accordingly, the ribbon microphones were heavy and enormous. Another issue was the ribbon inside the ribbon microphones. The tension of the ribbon is a vital factor in ribbon microphone sound characteristic. The ribbons made of thin aluminum foil that is brittle and by a blast of air, quickly deform and lose tension. Consequently, the ribbon put out of place and the microphone start to generating distortion and lose its original frequency response.

By presents of condenser and dynamic microphones with higher signal output, less noise, better frequency response, smaller size and lower weight, the ribbon microphones began to replace by condenser and dynamic microphones.

As the audio industry transferring from analog to digital, engineers discovered ribbon microphones sounds more natural in compare to condenser and dynamic microphones. The warmth and natural sound of the ribbon microphones especially smooth high frequencies were reasons to raised new demands for Ribbon microphones. On the other hand, material science have developed through years after early ribbons. A new generation of ribbon microphones begins to attract the microphone market.

As the demands are raised for ribbon microphones many company starts to research and develop ribbon microphones with today's technology. The old magnets such as Alnico magnets replaced by neodymium magnets for stronger magnetic field. New transformers and buffer amps are designed to maximize the sensitivity and terminate the risk of damaging ribbon by phantom power. Furthermore, new alternative ribbons are introduced to the market called film ribbon. Referring to U.S. Pat. No. 8,218,795 B2 the film ribbons are much stronger and having an elastic inherent to keep their original shape and tension by use of polyethylene terephthalate film polymer and a new method of corrugating. The shape memory of the new ribbon helps the ribbon to returns to the original shape any time it tensioned by blast of air or phantom power short circuiting or any other reason.

New ribbon microphones are growing fast due to the nature of their sound, practical size, and acceptable output signal sturdiness in compare of the earlier versions. However, the biggest potential of modern day ribbon microphones are not revealed yet. Something that none of the other type of microphones capable of it. The ability to control the tension of the ribbon by user.

With the old ribbon materials, it was impossible to change the tension of the ribbon repeatedly. Instead, the new alternatives materials can be used as an advantage to build a tunable ribbon microphone with a function to change the tension of the ribbon easily and quickly by the user. Thus, the user always has the choice to set the ribbon tension back to the factory default or explore new characteristics. In conventional microphones, the tension of the ribbon or diaphragm of microphones are always precisely adjusted in manufacture depend on the use of the microphone, and user do not have any control of it. So in conventional microphones recording engineer always use many microphones with different characteristic that sweet a particular type of sound, and they have to change many microphones to reach their desired result. The different tension of ribbon or diaphragm can produce different frequency and dynamic response. The ability to change ribbon tension in tunable ribbon microphone help the recording engineer to have more options before deciding to change the microphone. Different tension of the ribbon not only change the frequency response and harmonics, the tension of the ribbon have a direct effect on initial attack and resonates in dynamic form of the captured sound. By controlling the tension of the ribbon one can achieve much broader possibilities to record a sound. The process to find the desired result can be much faster, and the result would be more interesting by using tunable ribbon microphones. Instead, using conventional microphone and changing many microphones to find the best microphone for the purpose of recording would be time-consuming and in some cases impossible without using a tunable ribbon microphone.

The Tunable ribbon microphone bring a new world of experimenting for audio engineers to discover the effect of different tension of the ribbon on different sound source output. The tunable ribbon microphone potentially revolutionize microphone industry and open up new angle of development for microphone designers and manufacturers.

It is therefore an object of invention to provide control over pressure of the ribbon by user.

It is another object of the invention to provide an improved structure for a ribbon microphone which is simple in construction, cost effective and more practical than the conventional ribbon microphones.

It is another object of the invention to provide fast, easy and precise way to adjusting the pressure of the ribbon on ribbon microphone.

It is another object of the invention to provide a ribbon microphone that can be specifically and precisely adjusted for different situations and sound sources.

It is another object of the invention to provide a ribbon microphone that be more practical tools for recording vocal due to many different characteristics on vocal sounds.

It is another object of the invention to provide ability to tune ribbon pressure for certain fundamental frequency matched by sound source to capture most of the harmonics.

It is yet another object of the invention to provide ability to adjust the microphone to be capable of capture ultra-high pressure sound sources.

It is yet another object of the invention to control the dynamic of signal before using any signal compressor by just adjusting suitable pressure on ribbon depends on sound source level.

It is yet another object of the invention to emphasis certain frequencies on sound source and shape our sound before any conversion.

It is yet another object of the invention to be able to record more variety of sound by just one microphone.

### SUMMARY OF THE INVENTION

In accordance with the present invention, there is provided a tunable ribbon microphone having magnets positioned adjacent with small air gap in between pieces in opposite pole. An elastic ribbon placed in the air gap between the magnets by adjustable ribbon holder structure. The adjustable ribbon holder structure include two ribbon holders and a ribbon tension control. The ribbon holder can be fixed from one side and sliding on the other side or sliding on both sides. The ribbon tension control adjust the tension of the elastic ribbon. By turning the ribbon tension control, turning motion translate to linear motion and change the position of adjustable ribbon holder. Accordingly effect the distance between the ribbon holders and alter the tension of the ribbon. The amount of tension can be measured by the help of measurement bar imprinted on ribbon tension control. The tunable ribbon microphone may have more than one ribbon, adjustable ribbon holder structure and ribbon tension control.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front section view of a tunable ribbon microphone;

FIG. 2 is a perspective view of a magnetic field structure;

FIG. 3 is an exploded view of an adjustable ribbon holder structure;

FIG. 4 is an exploded view of a wiring system;

FIG. 5 is a detail view of an adjustable ribbon holder structure; and

FIG. 6 is a front and side view of a tunable ribbon microphone.

For purposes of clarity and brevity, like elements and components will bear the same designations and numbering throughout the Figures.

### DESCRIPTION OF THE PREFERRED EMBODIMENT

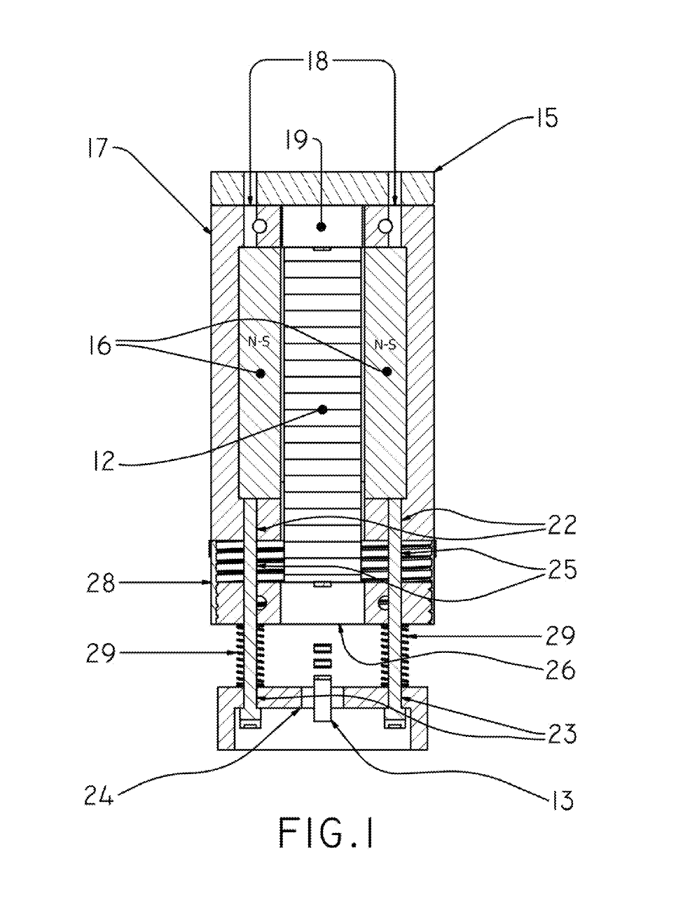

FIG. 1 is a front section view of a tunable ribbon microphone.

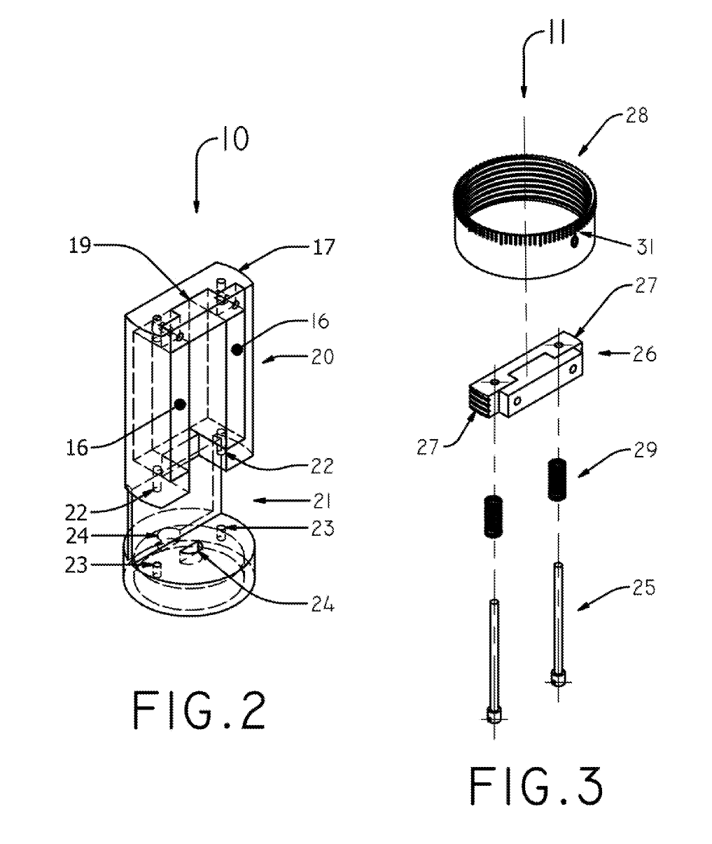

FIG. 2 is a perspective view of a magnetic field structure 10.

FIG. 3 is an exploded view of an adjustable ribbon holder structure 11.

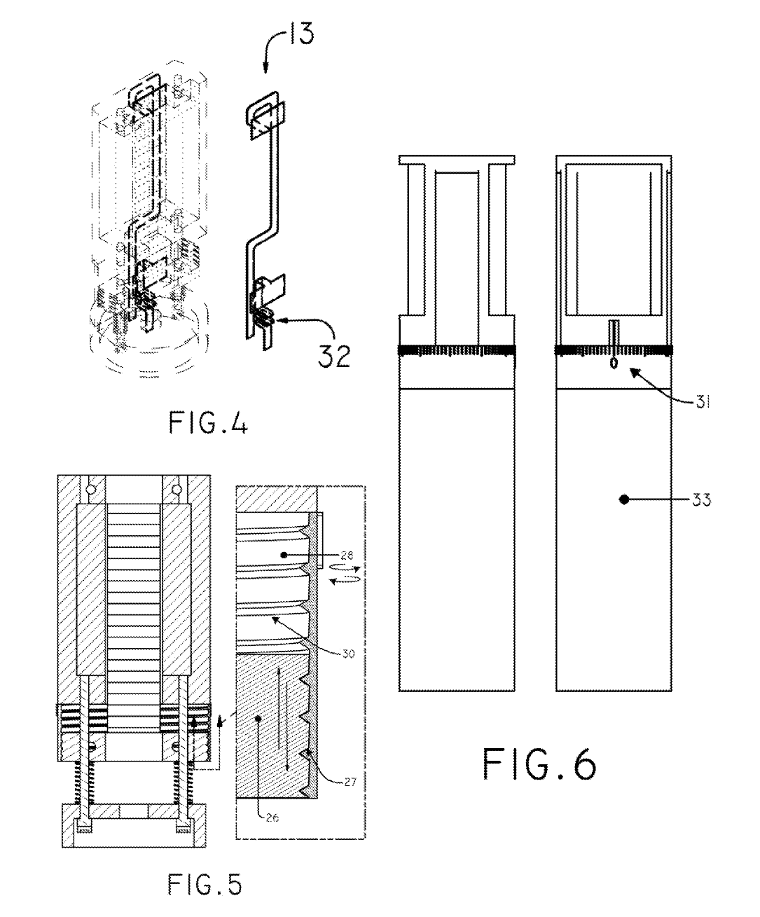

FIG. 4 is an exploded view of a wiring system 13.

FIG. 5 is a detail view of an adjustable ribbon holder structure 11.

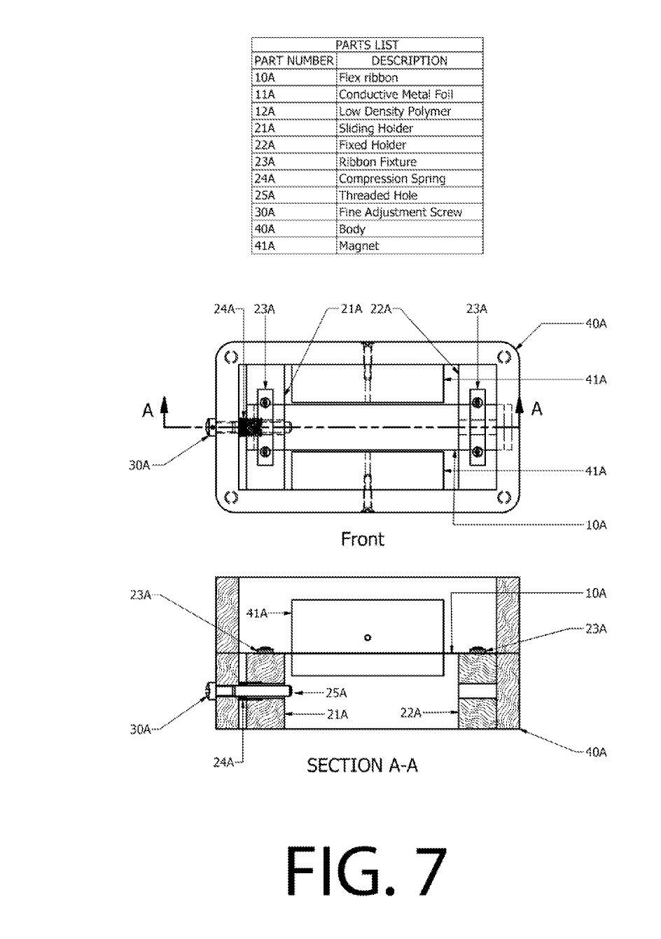

FIG. 6 is a front and side view of a tunable ribbon microphone.

A tunable ribbon microphone (FIG. 1) comprises a magnetic field structure 10 (FIG. 2), adjustable ribbon holder structure 11 (FIG. 3), and a ribbon 12 (FIG. 1). Along with wiring system 13 (FIG. 4), signal adjustment components and a protection shield.

Referring to FIG. 2 the magnetic field structure 10 provides the required magnetic field for the ribbon 12 to generate sound signals. The magnetic field structure 10 includes magnets 16 and the main body 17 which also serve as a support for the elements of the microphone. At least a pair of magnets 16 in parallel and the opposite pole placed to the main body 17 with an air gap in between. The magnets 16 are attached to the main body 17 by any suitable method such as weld or glued.

The main body 17 made of a solid material and includes a fixed ribbon holder 19, magnets placement area 20, adjustable ribbon holder placement area 21; middle body threaded holes 22, lower body holes 23, and wiring holes 24. The magnetic field structure's shape and components could change in order to maximizing the magnetic field in the ribbon 12 area. A tunable ribbon microphone can hire different mechanism rather than magnetic field structure 10 to capture sound signals such as using movement capture sensors to capture the ribbon 12 or diaphragm movements. In this case may the ribbon 12 or diaphragm do not require to be conductive, and the size of the tunable ribbon microphone become much smaller due to the elimination of magnets 16 in magnetic field structure 10. Overall shape of tunable ribbon microphone can vary, and the attached drawings are examples to help better understanding of the invention.

The adjustable ribbon holder structure 11 (FIG. 3) altering the tension of the ribbon 12 by changing the distance of the ribbon holders 19 and 26 or folding or rolling ribbon 12 on one side or both sides. The adjustable ribbon holder structure 11 can be motorize, in this case we can control the tension of the ribbon 12 digitally and more precise.

The main purpose of the adjustable ribbon holder structure 11 is to control the tension of the ribbon 12, and the design of the structure is not restricted to the following examples.

The adjustable ribbon holder structure 11 consist of a pair of ribbon holder supports 25, an adjustable ribbon holder 26 with round threaded sides and a ribbon tension control 28. The ribbon holder supports 25 inserted through the lower body holes 23 in the main body 17 and tightened to the middle body threaded holes 22. Preferably a pair of rubber compression springs 29 inserted to the ribbon holder supports 25 and forcing adjustable ribbon holder 26 to return to its default position. The compression springs 29 also stop the adjustable ribbon holder 26 from rattling and smooth out the movement of ribbon tension control 28. Referring to FIGS. 1 and 2 adjustable ribbon holder 26 place in the adjustable ribbon holder placement area 21 by the ribbon holder supports 25. Ribbon holder supports 25 fastened to middle body threaded holes 22 of the main body 17. Referring FIGS. 3 and 5 the ribbon tension control 28 is a ring with threads 30 inside. By engaging the ribbon tension control 28 to the adjustable ribbon holder's threads 27, we can control the movement of the adjustable ribbon holder 26. By turn the ribbon tension control 28, the rotating motion translate to linear motion and move the adjustable ribbon holder 26 in axis of ribbon holder supports 25. The preciseness of movement of the adjustable ribbon holder 26 depends on the size of the threads 30 inside the motion control ring and the adjustable ribbon holder's threads 27.

Referring to FIG. 7 as another example of adjustment ribbon holder structure a fine adjustment screw pass through the body form outside and connected to the sliding ribbon holder. A compression spring placed between the body and the sliding ribbon holder. The compression spring forced the ribbon holder toward the center of the microphone and kept the sliding ribbon holder steady. By help of the compression spring, turning the fine adjustment screw move the sliding ribbon holder toward the center of the microphone or in reverse. The movements of the sliding ribbon holder alter the distance between two ribbon holders and change the tension of the ribbon.

Yet another example of adjustment ribbon holder structure is to use two partially threaded screws rigidly tightened to the body. The sliding ribbon holder and two compression springs located between the partially threaded screws and the main body. The compression springs are between sliding ribbon holder and head of the partially threaded screws. The compression springs keep the sliding ribbon holder in place and control the movement of it. With the help of a fine threaded hole or a fine threaded bush within the body and a fine adjustment screw we can control the position of the sliding ribbon holder. By turning the fine adjustment screw in one direction, moves more into the body and push the sliding ribbon holder to the center of the microphone. Therefore, turning the fine adjustment screw in reverse, moves the fine adjustment screw out of the body so the spring force the sliding ribbon holder back to the sides.

Adjustable ribbon holder structure 11 may have more than one adjustable ribbon holder 26 and ribbon tension control 28 and may not have any fixed ribbon holder 19. The parts can positioned differently depend on numbers of ribbons 12 and ribbon holders 26 and/or 19.

Referring to FIG. 1 the ribbon 12 is placed in the air gap between the magnets 16 precisely by adjustable ribbon holder structure 11 and secured by ribbon fixtures. The ribbon 12 made of one or layers of thin and light conductive or elastic or conductive and elastic materials such as patent No.: “U.S. Pat. No. 8,218,795 B2” or “U.S. Pat. No. 8,331,588 B2” or any new upcoming materials with the desire property inherent. The ribbon 12 can corrugate and/or perforated partially and/or pinpointed to optimize sensitivity for different frequency range. The ribbon 12 preferably is 2.5 micron thick, 3/16″ wide and 1.5″ long in the default tension. The ribbon 12 should have moderate elasticity inherent and ability to return to its default tension as it tensioned repeatedly. The shape and sizes of the ribbon 12 vary depend on the functionality. Referring to patent No.: “U.S. Pat. No. 2,699,474” movements of sound waves in the air vibrate the ribbon 12 and the movement of the ribbon 12 converted to the audio signal.

Referring to FIGS. 4a and 4b the preferred wiring system 13 includes wires routing from each side of the ribbon 12 to the wiring holes 24 in the main body 17 and connected to the signal adjustment components. Using insulated ribbon wires 13 and stick to the main body 17 prevent any probable undesired sounds made by the movements of the wires. The wires placed under the ribbon 12 and rigidly stick to the ribbon holders 19 and 26. The ribbon 12 and wiring system 13 have to insulate from all the other parts and connected to signal adjustment components. Referring to FIG. 4b as an example of the wiring system 13, the wire attached to the adjustable ribbon holder 26 preferably folded 32 to achieve better coordination with the adjustable ribbon holder 26 actions.

Usually, the signal produced by the ribbon 12 is low current. So the signal adjustment components are raise and balanced the current by use of a step up transformer by factor of 1:20 or 1:25. The signal adjustment components can vary depend on desired signal output. The signal adjustment components can be one or two transformers with different ratio in conjunction with a tube or transistor buffer amplifier. The signal adjustment components preferably placed in lower body 33 of the tunable ribbon microphone to minimize magnetic interferences and feed by the ribbon's 12 signals. The final signal routed to the microphone output connector.

Referring to FIGS. 5 and 6 by turn the ribbon tension control 28 the adjustable ribbon holder 26 moves closer to the center of the microphone. The distance between the adjustable ribbon holder 26 and the fixed ribbon holder 19 decrease and the ribbon 12 loosen up. Apparently by turn the ribbon tension control 28 in the opposite direction, the adjustable ribbon holder 26 holder start to move in reverse and the ribbon 12 become tense. Different tension of the ribbon 12 cause distinctive response to the sound source, and it gives the ability to shape the sound before it converted to signal that it is not possible in conventional microphones. The amount of tension can be measured by the measurement bar 31 imprinted on ribbon tension control 28. So the tension of the ribbon 12 can be back to factory default setting at any time.

The ribbon tension control 28 can be equipped with a locking system to keep the ribbon tension control 28 from changing when it is unnecessary.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A tunable ribbon microphone for build a ribbon microphone with the ability to adjust the tension of the ribbon by the user depends on sound source and desire sound characteristic, comprising:
means for providing required magnetic field and used as a main body for other components;
means for keep all the elements in place;
means for generates magnetic field, rigidly attached to said means for providing required magnetic field and used as a main body for other components;
means for keep the ribbon in place from one side, rigidly constructed to said means for providing required magnetic field and used as a main body for other components;
means for provide a mechanism to precisely control the tension of the ribbon, rigidly assembled to said means for providing required magnetic field and used as a main body for other components;
means for precisely control and measure the movement of adjustable ribbon holder;
means for keep the ribbon in place, turn ably connected to said means for precisely control and measure the movement of adjustable ribbon holder, and slid ably assembled to said means for provide a mechanism to precisely control the tension of the ribbon.
means for restrict the axial movement of adjustable ribbon holder, rigidly connected to said means for provide a mechanism to precisely control the tension of the ribbon, and rigidly connected to said means for providing required magnetic field and used as a main body for other components;
means for route the ribbon signals to the signal adjustment components, tightly connected to said means for keep the ribbon in place, and tightly connected to said means for keep the ribbon in place from one side; and
means for capture the movements off the air and convert them to electrical signal, tightly connected to said means for route the ribbon signals to the signal adjustment components, tightly placed to said means for keep the ribbon in place, and tightly placed to said means for keep the ribbon in place from one side.

2. The tunable ribbon microphone in accordance with claim 1, wherein said means for providing required magnetic field and used as a main body for other components comprises a magnetic field structure.

3. The tunable ribbon microphone in accordance with claim 1, wherein said means for keep all the elements in place comprises a strong main body.

4. The tunable ribbon microphone in accordance with claim 1, wherein said means for generates magnetic field comprises magnets.

5. The tunable ribbon microphone in accordance with claim 1, wherein said means for keep the ribbon in place from one side comprises a fixed ribbon holder.

6. The tunable ribbon microphone in accordance with claim 1, wherein said means for provide a mechanism to precisely control the tension of the ribbon.

7. The tunable ribbon microphone in accordance with claim 1, wherein said means for precisely control and measure the movement of adjustable ribbon holder comprises a threaded on the inside, imprinted measurement bar on the outside ribbon tension control.

8. The tunable ribbon microphone in accordance with claim 1, wherein said means for keep the ribbon in place.

9. The tunable ribbon microphone in accordance with claim 1, wherein said means for restrict the axial movement of adjustable ribbon holder. The adjustable ribbon holder sliding through the adjustable ribbon holder sliders comprises an adjustable ribbon holder sliders.

10. The tunable ribbon microphone in accordance with claim 1, wherein said means for route the ribbon signals to the signal adjustment components comprises a conductive wiring system.

11. The tunable ribbon microphone in accordance with claim 1, wherein said means for capture the movements off the air and convert to electrical signal comprises an elastic ribbon.

12. A tunable ribbon microphone for build a ribbon microphone with the ability to adjust the tension of the ribbon by the user depends on sound source and desire sound characteristic, comprising:
a magnetic field structure, for providing required magnetic field and used as a main body for other components;
a strong main body, for keep all the elements in place;
magnets, for generates magnetic field, rigidly attached to said magnetic field structure;
a fixed ribbon holder, for keep the ribbon in place from one side, rigidly constructed to said magnetic field structure;
an adjustable ribbon holder structure, for provide a mechanism to precisely control the tension of the ribbon, rigidly assembled to said magnetic field structure;
a threaded on the inside, imprinted measurement bar on the outside ribbon tension control, for precisely control and measure the movement of adjustable ribbon holder;
a threaded sides adjustable ribbon holder, for keep the ribbon in place, turn ably connected to said ribbon tension control, and slid ably assembled to said adjustable ribbon holder structure;
an adjustable ribbon holder sliders, for restrict the axial movement of adjustable ribbon holder, rigidly connected to said adjustable ribbon holder structure, and rigidly connected to said magnetic field structure;
a conductive wiring system, for route the ribbon signals to the signal adjustment components, tightly connected to said adjustable ribbon holder, and tightly connected to said fixed ribbon holder; and
an elastic ribbon, for capture the movements off the air and convert to electrical signal, tightly connected to said wiring system, tightly placed to said adjustable ribbon holder, and tightly placed to said fixed ribbon holder.

13. The tunable ribbon microphone as recited in claim 12, further comprising:
a springs, for prevent unnecessarily movements of adjustable ribbon holder, freely connected to said adjustable ribbon holder structure, freely assembled to said adjustable ribbon holder, and freely assembled to said adjustable ribbon holder sliders.

14. The tunable ribbon microphone as recited in claim 12, wherein said main body is Non ferromagnetic.

15. The tunable ribbon microphone as recited in claim 12, wherein said magnets is neodymium.

16. The tunable ribbon microphone as recited in claim 12, wherein said adjustable ribbon holder is sliding.

17. The tunable ribbon microphone as recited in claim 12, wherein said wiring system is folded.

18. The tunable ribbon microphone as recited in claim 12, wherein said ribbon is conductive.

19. A tunable ribbon microphone for build a ribbon microphone with the ability to adjust the tension of the ribbon by the user depends on sound source and desire sound characteristic, comprising:
a magnetic field structure, for providing required magnetic field and used as a main body for other components;
a non-ferromagnetic, strong main body, for keep all the elements in place;
a neodymium magnets, for generates magnetic field, rigidly attached to said magnetic field structure;
a fixed ribbon holder, for keep the ribbon in place from one side, rigidly constructed to said magnetic field structure;
an adjustable ribbon holder structure, for provide a mechanism to precisely control the tension of the ribbon, rigidly assembled to said magnetic field structure;
a threaded on the inside, imprinted measurement bar on the outside ribbon tension control, for precisely control and measure the movement of adjustable ribbon holder;
a threaded sides, sliding adjustable ribbon holder, for keep the ribbon in place, turn ably connected to said ribbon tension control, and slid ably assembled to said adjustable ribbon holder structure;
a springs, for prevent unnecessarily movements of adjustable ribbon holder, freely assembled to said adjustable ribbon holder, and freely connected to said adjustable ribbon holder structure;
an adjustable ribbon holder sliders, for restrict the axial movement of adjustable ribbon holder, freely assembled to said springs, rigidly connected to said adjustable ribbon holder structure, and rigidly connected to said magnetic field structure;
a folded, conductive wiring system, for route the ribbon signals to the signal adjustment components, tightly connected to said adjustable ribbon holder, and tightly connected to said fixed ribbon holder; and
an elastic, conductive ribbon, for capture the movements off the air and convert to electrical signal, tightly connected to said wiring system, tightly placed to said adjustable ribbon holder, and tightly placed to said fixed ribbon holder.
